(19) United States
(12) Patent Application Publication
(10) Pub. No.: US 2022/0024835 A1
(43) Pub. Date: Jan. 27, 2022

(54) A SYSTEM FOR PROVIDING NUTRIENTS TO PLANTLETS

(71) Applicant: Global Treegro Inc., Vancouver (CA)

(72) Inventor: Kenneth A. TURPIN, Surrey (CA)

(21) Appl. No.: 17/423,839

(22) PCT Filed: Jan. 20, 2020
(86) PCT No.: PCT/CA2020/050059

§ 371 Date: Jul. 16, 2021

(30) Foreign Application Priority Data
Jan. 21, 2019 (CA) 3031110

(51) Int. Cl. C05G 3/70; C05G 3/80; C05F 11/10; C05F 17/05; A01N 43/12; A01N 25/10; A01C 1/06

(52) U.S. Cl. CPC C05G 3/70; C05G 3/80; C05F 11/10; A01C 1/06; A01N 43/12; A01N 25/10; C05F 17/05

(57) ABSTRACT

The present application relates to a system for providing nutrients to plantlets, the system comprising: a water controlling agent, an organic waste material, a seed germination enhancer, a binding material. The water controlling agent may be a super absorbent polymer. The organic waste material may be worm casting. The seed germination enhancer may be selected from a group consisting of GA3, GA 4+7, and a combination thereof. The ratio of the water controlling agent to the organic waste material may be between about 1:1 and about 1:6.

### TECHNICAL FIELD

The present disclosure relates to a system for providing nutrients to plantlets.

### BACKGROUND

Many hectares of agricultural crops and forests are lost every year around the world due to phenomena such as drought, deforestation, insect infestation, and forest fires. Evolving farming and re-forestation practices demand that such problems are not merely solved by innovation, but also solved in a manner that is environmentally acceptable and sustainable.

It has been suggested that the most significant difficulties and highest losses of potential crops arise in establishing the germination and growth of a plant in the first instance. It has also been shown that plants in general, once established in a suitable environment, are, for the most part, self-sufficient and may be cultivated. As a result, research has been directed towards discovering ways of improving the likelihood that plant seeds become established as plantlets.

Forest regeneration depends, to a large extent, on seedling emergence and establishment, both of which are influenced by environmental and climatic variables. Large nurseries have been established to produce seedlings to be used in reforestation applications. To produce large number of forest seedlings needed for reforestation, sufficient time (generally one year minimum) is required to grow the seedlings before such seedlings can be transplanted to a target site. By nature, this is also a labour and resource intensive process. In addition, after transplanting, some seedlings may experience transplanting shock, such as physiological stresses, owing to a change in environment. Transplant shock may result in negative effects on the seedlings' establishment, growth, and survival.

In an effort to move away from labour intensive practices associated with nurseries, various research groups have presented innovations that improve the likelihood that plant seeds can become established as plantlets. For example, U.S. Pat. No. 4,249,343 to Dannelly discloses various compositions of water-insoluble but water-sensitive polymeric microgels that may be used as a seed coating for providing protection for seeds. However, the polymer disclosed therein does not dissolve when contacted with water. In another example, Turpin discloses in CA Pat. No. 2,000,620 a plantable water-imbibing seed-containing tablet that forms into a gel capsule when contacted with sufficient moisture, the gel capsule enveloping a seed therein and providing said seed with nutrients required for developing into a plantlet.

Some prior art innovations that improve the likelihood that plant seeds become established as plantlets also incorporate chemical compounds essential to the invention; however, such chemical compounds may be regulated by government agencies, and therefore cannot be widely used or adopted (if used or adopted at all).

Prior art studies have shown that soil microbials and fungi can have direct effects on seedling growth and functional traits (Friesen, M. L. et al., 2011. Microbially mediated plant functional traits. Ann. Rev. Ecol. Evol. Syst. 42, 23-46). For example, it has been suggested that the addition of mycorrhizal fungi increases the root's absorptive area and thus increases the root's access to water and nutrients (Chen M. et al., 2018. Beneficial services of arbuscular mycorrhizal fungi—from ecology to application. Front PlantSci 9:1270). It has also been suggested that an increase in root surface area conferred by mycorrhiza can assist seedlings increase above-ground biomass better than seedlings without mycorrhiza, thereby ensuring better survival and outplanting performance (Kannenberg, S. A., Phillips, R. P., 2016. Soil microbial communities buffer physiological responses to drought stress in three hardwood species. Oecologia 183, 631-641).

Prior art studies have also shown that gibberellins can assist in enhancing conifer seed germination (Henig-Sever N et al., 2000. Regulation of the germination of Aleppo pine (Pinus halepensis) by nitrate, ammonium, and gibberellin, and its role in post-fire forest regeneration. Physiologia Plantarum 108: 390-397). Prior art studies have shown that the combination of water absorbent polymers and organic matter may improve soil water retention and performance of seedlings grown in reclaimed areas (Miller V. S. et al., 2019. Hydrogel and Organic Amendments to Increase Water Retention in Anthroposols for Land Reclamation. Applied and Environmental Soil Science vol. 2019, Article ID 4768091).

### SUMMARY

The present disclosure relates to a system for providing nutrients to plantlets. The system can be deployed in areas requiring re-forestation.

It is an object of the system disclosed herein to provide a seedling with immediate access to nutrients in order to grow and establish in an otherwise harsh environment (e.g. drought, frost, fire ravaged area) that lacks sufficient nutrients critical for initial seedling establishment.

It is an object of the system disclosed herein to provide a means for re-seeding a deforested area in a more cost effective and less labour intensive way than traditional nursery production.

According to a part of the disclosure, there is a system for providing nutrients to plantlets, the system comprising a water controlling agent, an organic waste material, a seed germination enhancer, a binding material.

The water controlling agent may be a super absorbent polymer. The organic waste material may be worm casting. The seed germination enhancer may be selected from the group consisting of GA3, GA 4+7, and a combination thereof. The seed germination enhancer may be GA3. The seed germination enhancer may be a combination of GA3 and GA 4+7. The binding material may be microcrystalline cellulose.

The ratio of the water controlling agent to the organic waste material may be between about 1:1 and about 1:6. The ratio of the water controlling agent to the organic waste material may be between about 1:1 and about 1:3.

The ratio of the organic waste material to the seed germination enhancer is between about 13000:1 and about 19000:1. The ratio of the organic waste material to the seed germination enhancer is between about 16000:1 and about 18000:1.

The ratio of water controlling agent to flow agent is between about 20:1 and about 2:1. The ratio of water controlling agent to flow agent is between about 15:1 and about 10:1.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF THE DRAWINGS

In the accompanying drawings, which illustrate one or more embodiments:

FIG. 1 is a first graph of results of various systems in an experiment evaluating the percentage of emergence of seeds with said various systems.

FIG. 2 is a second graph of results of various systems in an experiment evaluating the percentage of emergence of seeds with said various systems.

FIG. 3(a) is a perspective view of a system for providing nutrients to a plantlet according to an embodiment.

FIG. 3(b) is a top view of the system according to FIG. 3(a).

FIG. 3(c) is a side view of the system according to FIG. 3(a).

FIG. 3(d) is a sectioned side view of the system according to FIG. 3(a), as cut along section plane 1-1 of FIG. 3(c).

FIG. 4(a) is a perspective view of a system for providing nutrients to a plantlet according to another embodiment.

FIG. 4(b) is a top view of the system according to FIG. 4(a).

FIG. 4(c) is a side view of the system according to FIG. 4(a).

FIG. 4(d) is a sectioned side view of the system according to FIG. 4(a), as cut along section plane 2-2 of FIG. 4(c).

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one; for example, the term “plurality includes two or more, three or more, four or more, or the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

In this disclosure, the term “about”, when followed by a recited value, means within plus or minus 5% of that recited value.

In this disclosure, “dry matter”, when referring to organic waste material, means the matter of the organic waste material when water or moisture is removed from the organic waste material.

In this disclosure, the term “fertilizer” refers to a synthetic fertilizer (e.g. ammonium nitrate, ammonium phosphate), and does not refer to an organic fertilizer (e.g. compost, manure, worm castings).

In this disclosure, “organic matter”, when referring to organic waste material, means decomposed materials found in the organic waste material.

In this disclosure, the term “organic waste material” refers to a waste by-product produced by an animal (e.g. an organic fertilizer).

In this disclosure, the term “seed enhancer” means a chemical for improving the likelihood of seed performance consistency.

In this disclosure, the term “water-imbibing unit” means a composition that is capable of absorbing water.

### System for Providing Nutrients to Plantlets

The present disclosure relates to a system for providing nutrients to plantlets. The system can be adapted for use in improving the planting, germination, and growth of tree seeds and seedlings. The system can be adapted to receive one or more seeds or seedlings therein.

Embodiments of the system disclosed herein comprise water controlling agents. In some embodiments, the system further comprises a fertilizer. In some embodiments, the system further comprises one or more binding materials. In some embodiments, the system further comprises one or more dispersants. In some embodiments, the system further comprises one or more flow control agents. Embodiments of the system herein comprise one or more organic waste materials. In some embodiments, the system further comprises one or more fungal materials. In some embodiments, the system further comprises one or more seed germination enhancers. In some embodiments, the system further comprises one or more deterrents. In some embodiments, the system further comprises one or more pH modifiers. In some embodiments, the system further comprises one or more seed coating resins. In some embodiments, the system further comprises one or more powders for seed coating. In some embodiments, the system comprises some or all of the foregoing components above.

A water controlling agent serves, at least in part, to absorb and expand upon contact with water, thereby providing an environment wherein other components (e.g. fertilizers) of the system can become water soluble and have the potential to be bio-available for seeds to develop into seedlings. Non-limiting examples of a water controlling agent suitable for use in a system for providing nutrients to plantlets include acrylate polymers, super absorbent polymers (e.g. SAP, Guangrao Huadongshangcheng), other suitable water controlling agents, and a combination thereof. An example of another suitable water controlling agent is a potassium-based acrylate polymer. Another example of another suitable water controlling agent is a poly(acrylic acid) partial potassium salt (e.g. CAS: 25608-12-2). The water controlling agent generally comprises about 10% to about 80% of the overall dry weight of the system. For example, the water controlling agent can comprise about 10% to about 70%, about 10% to about 60%, about 10% to about 50%, about 10% to about 40%, about 10% to about 30%, about 20% to about 60%, about 20% to about 50%, about 20% to about 40%, about 20% to about 30%, about 30% to about 60%, about 30% to about 50%, about 30% to about 40%, about 40% to about 60%, about 40% to about 50%, about 50% to about 60% of the overall dry weight of the system. For example, the water controlling agent can comprise about 35% to about 45% of the overall dry weight of the system.

A binding material serves, at least in part, to promote adhesiveness between the components of the system and to allow for compressibility of the system. Non-limiting examples of a binding material suitable for use in a system for providing nutrients to plantlets include microcrystalline cellulose material, starch, flour, other suitable binding materials, and a combination thereof. Examples of suitable starch include, but are not limited to, native starches, modified starches, polysaccharides, and a combination thereof. Examples of native starches include, but are not limited to, potato starches, corn starches, wheat starches, oat starch, barley starch, rice starches, sorghum starches, and tapioca starches. Examples of modified starches include, but are not limited to, esterified starch, starch phosphate, etherified starches, cross-linked starches, cationized starches, enzymatically digested starches, and oxidized starches. The binding material generally comprises about 5% to about 30% of the overall dry weight of the system. For example, the binding material can comprise about 5% to about 25%, about 5% to about 20%, about 5% to about 15%, about 5% to about 10%, about 10% to about 25%, about 10% to about 20%, about 10% to about 15%, about 15% to about 25%, about 15% to about 20%, of the overall dry weight of the system.

A dispersant serves, at least in part, to facilitate dissolution of a compressed system after said system contacts water. Non-limiting examples of dispersants suitable for use in a system for providing nutrients to plantlets include ammonia-free dispersants, formaldehyde-free dispersants, other suitable dispersants, and a combination thereof. In some embodiments, there is no dispersant.

A flow control agent serves, at least in part, to decrease the likelihood of components of the system adhering to equipment used in the manufacturing thereof. Non-limiting examples of a flow control agent suitable for use in a system for providing nutrients to plantlets include stearates (e.g. magnesium stearate), other suitable flow control agents, and a combination thereof. The flow control agent generally comprises about 1% to about 15% of the overall dry weight of the system. For example, the binding material can comprise about 1% to about 5%, about 1% to about 10%, about 5% to about 10%, about 3% to about 8%, about 2% to about 7%, about 1% to about 3%, of the overall dry weight of the system.

An organic waste material serves, at least in part, to enhance nutrient uptake of certain components of the system, and may further impart one or more tolerances (e.g. drought tolerance, toxin tolerance, etc. . . . ) to one or more components of the system or the system as a whole. Non-limiting examples of an organic waste material suitable for use in a system for providing nutrients to plantlets include castings (e.g. worm castings), other suitable organic waste material, and a combination thereof. Examples of suitable castings include those from Red Wrigglers. The organic waste material generally comprises about 20% to about 45% of the overall dry weight of the system. For example, the organic waste material can comprise about 20% to about 40%, about 20% to about 35%, about 20% to about 30%, about 20% to about 25%, about 25% to about 35%, about 25% to about 30%, of the overall dry weight of the system.

A fungal material is, at least in part, intended to enhance a plant root's absorptive area for increasing water and nutrient absorption. Non-limiting examples of fungal materials include mycorrhizal fungi and ectomycorrhiza fungi (e.g. Root Rescue Environmental Products Inc., Waterdown, Ontario, Canada). The fungal material generally comprises about 2% to about 8% of the overall dry weight of the system. In some embodiments, there is no fungal material.

A fertilizer serves, at least in part, to provide nutrients (e.g. macro-nutrients, micro-nutrients, or both) for supporting seed germination, early seedling development, or both. Non-limiting examples of fertilizers suitable for use in a system for providing nutrients to plantlets include ammonium containing fertilizers, urea containing fertilizers, nitrogen containing fertilizers, calcium containing fertilizers, magnesium containing fertilizers, sulfur containing fertilizers, sulfate containing fertilizers, boron containing fertilizers, borate containing fertilizers, copper containing fertilizers, manganese containing fertilizers, zinc containing fertilizers, transition metal containing fertilizers, phosphate containing fertilizers, potassium containing fertilizers, oxide containing fertilizers, potash, and a combination thereof. The fertilizer generally comprises about 2% to about 40% of the overall dry weight of the system. For example, the fertilizer can comprise about 2% to about 35%, about 2% to about 30%, about 2% to about 25%, about 2% to about 20%, about 2% to about 15%, about 2% to about 10%, about 2% to about 5% of the overall dry weight of the system. Fertilizer can be in a granulated formulation. Fertilizer can be in a slow-release formulation. In some embodiments, there is no fertilizer in the system.

A seed germination enhancer serves, at least in part, to promote the germination of seeds. Non-limiting examples of a seed germination enhancer suitable for use in a system for providing nutrients to plantlets include those containing gibberellins, auxins, or both. Other non-limiting examples of a seed germination enhancer suitable for use in a system for providing nutrients to plantlets include those containing growth hormones, naphthalene acid, naphthalene acetic acid, salicylic acid, fulvic acid, humic acid, butyric acid, gibberellic acid (e.g. GA-3, GA 4+7), other suitable seed germination enhancers, and a combination thereof. The seed germination enhancer can comprise up to about 0.05% of the overall dry weight of the system. For example, the seed germination enhancer can comprise between about 0.001% to about 0.05%, about 0.001% to about 0.04%, about 0.001% to about 0.03%, about 0.001% to about 0.02%, about 0.001% to about 0.01%, about 0.01% to about 0.05%, about 0.01% to about 0.04%, about 0.01% to about 0.03%, about 0.01% to about 0.02% of the overall dry weight of the system. For example, the seed germination enhancer can comprise about 0.01%, 0.02%, 0.03%, 0.04%, 0.05% of the overall dry weight of the system. In some embodiments, there is no seed germination enhancer in the system.

A deterrent serves, at least in part, to deter living organisms from consuming the system or any part thereof. Non-limiting examples of a deterrents suitable for use in the system include benzoates, other suitable deterrents, and a combination thereof. Non-limiting examples of benzoates include denatonium benzoate. In some embodiments, there is no deterrent in the system.

A pH modifier serves, at least in part, to maintain the pH levels of the system. Non-limiting examples of a pH modifier suitable for use in a system for providing nutrients to plantlets include compounds that are able to maintain a pH of a medium at between about 5 and about 6. In some embodiments, there is no pH modifier in the system.

A seed coating resin serves, at least in part, to provide a protective coating around a seed, to enhance a seed's germination rate, to enhance the viability of an emerging seedling, or any combination thereof. Non-limiting examples of a seed coating resin suitable for use in a system for providing nutrients to plantlets include acrylic latex polymers, co-polymer systems such as that taught in U.S. Pub. No. 2006/0240983 to Yamaguchi, compositions comprising an acrylamide monomer, other suitable seed coating resins, and a combination thereof. A non-limiting example of an acrylamide monomer is n-methylol (meth)acrylamide monomer. In some embodiments, there is no seed coating resin in the system.

A powder for seed coating serves, at least in part, to provide a protective coating around a seed, to enhance a seed's germination rate, to enhance the viability of an emerging seedling, or any combination thereof. Non-limiting example of powders for seed coatings include carbonate containing compositions, silicate containing compositions (including silica), aluminosilicate containing compositions (e.g. zeolite, bentonite, vermiculite), diatomaceous earth, and a combination thereof. An example of a carbonate containing composition is an alkaline earth metal carbonate (e.g. calcium carbonate). Examples of silicate containing compositions include, but are not limited to, talc and kaolinite. Powders can be dry. Powder seed coatings can be a coating known in the art such as that taught in U.S. Pat. No. 4,250,660 to Kitamura. In some embodiments, there is no powder for seed coating in the system.

Depending on where the system for providing nutrients to plantlets may be applied, used, distributed, or deployed, the composition of the system may vary both in terms of the used ingredients and the relative proportions thereof. The system may take the form that is known in the art including, but not limited to, a capsule (e.g. gel capsule, liquid capsule), a pod, a pill, and a tablet (see for example Turpin, CA 2,000,620). The system may also have a shape or size that is adapted for a particular application. An example of a system is a water-imbibing unit.

### Manufacturing a System for Providing Nutrients to Plantlets

According to an embodiment of manufacturing a system, worm castings were dried in a drying oven (e.g. Isotherm, Fisher Scientific, Pittsburgh, Pa., USA) at 40° C. until constant weight. The dried worm castings were pulverized using a high speed multi-functional crusher (e.g. BI-DTOOL 2000 gram Electric Grain Grinder). The pulverized dried worm castings were weighed and placed in a kitchen mixer (e.g. KitchenAid Classic Tilt-Head Stand Mixer). A mixture of whole and pulverized super absorbent polymer (e.g. SAP, Guangrao Huadongshangcheng 23-1, Shandong, China) was added into mixer in a suitable ratio to the worm castings (e.g. 1:1). Microcrystalline Cellulose (e.g. Ingredient Depot, North America, Canada) and talcum powder (e.g. Ingredient Depot, North America, Canada), were added. In some embodiments, ectomycorrhiza were added. In some embodiments, gibberellins (e.g. GA3, GA 4+7, or a combination thereof) were added. In some embodiments, fertilizer (e.g. Lawn fertilizer from Nutrient Ag Solutions comprising a fertilizer composition N 19%, P 12%, Soluble Potash 15% and sulphur 6%) was added. The mixed components may then be formed or compressed into a tablet or other suitable form.

According to another embodiment of manufacturing a system, components of a system are initially thoroughly dried through mechanisms or means known in the art. The dried components are then mixed thoroughly and then pelletized into a tablet. Pelletization of a system into a tablet is done by using a pelletizing machine capable of exerting a pressure anywhere between about 1 tonne and about 20 tonnes. For example, the pelletizing machine, in forming a water imbibing tablet, can exert a pressure of about 1 tonne, 2 tonnes, 3 tonnes, 4 tonnes, 5 tonnes, 6 tonnes, 7 tonnes, 8 tonnes, 9 tonnes, 10 tonnes, 11 tonnes, 12 tonnes, 13 tonnes, 14 tonnes, 15 tonnes, 16 tonnes, 17 tonnes, 18 tonnes, 19 tonnes, 20 tonnes. As contemplated in this embodiment, the pelletizing machine exerts a pressure of about 10 tonnes in the manufacture of the system. It is believed that 10 tonnes of pressure permits an appropriate level of cohesiveness between the various components of the system without adversely affecting the efficacy (e.g. through chemical or structural damage) of any one component thereof.

Method of Preparing Seed for Insertion into System

According to an embodiment of preparing seeds for insertion into the system, seeds are obtained from a seed provider (e.g. National Tree Seed Centre of the Canadian Forest Service). Suitable seeds include but are not limited to fir seeds, pine seeds, and spruce seeds. A non-limiting example of fir seeds is Douglas fir seeds. Non-limiting examples of pine seeds are Jack pine seeds and Lodgepole pine seeds. A non-limiting example of spruce seeds is white spruce seeds.

Seeds are immersed in a liquid medium for a pre-determined period of time and at a pre-determined temperature. As contemplated herein, the liquid medium is water, the pre-determined period of time is 24 hours, and the pre-determined temperature is room temperature (about 25° C.). In other embodiments, the liquid medium, the pre-determined period of time, and the pre-determined temperature may be selected according to the kind of seed to be planted. The seeds are then dried and stratified according to a method known in the art. For example, as contemplated herein, the seeds are dried and stratified at about 5 degrees Celsius for a 28 day period, as discussed in MacDonald, J. E., et al., 2012. Root growth of containerized lodgepole pine seedlings in response to Ascophyllum nodosum extract application during nursery culture. Can. J. Plant Sci. 92: 1207-1212).

After drying and stratification, seeds are ready and prepared for use within the system.

According to another embodiment, and depending on where and when a system is deployed into the environment, a seed located therein may be coated or may not be coated. Seed coatings generally are present for the purposes of physically protecting the seed from external variables (e.g. environmental variables). A seed coating is often applied when the environment in which the system containing the seed therein is deployed is not expected to experience a moisture event (e.g. a rainfall event) for a prolonged period of time (e.g. over a number of months).

As contemplated in an embodiment of preparing a seed for insertion into a system for providing nutrients to plantlets, the seed is initially submerged into a seed germination enhancer. As contemplated in this embodiment, a seed is submerged in a solution of gibberellins (e.g. GA3, GA 4+7). In other embodiments, other suitable seed germination enhancers are used. In other embodiments, the seed is not initially treated with a seed germination enhancer.

After initially treating with a seed germination enhancer, the seed can be coated with a dry powder. The dry powder may be any suitable combination of components. As contemplated in this embodiment, the dry powder is a mixture of diatomaceous earth, calcium carbonate, and talc.

The seed can then be coated with a seed coating resin. Suitable seed coating resins include, but are not limited to, acrylic latex polymers. An example of an acrylic latex polymer is one that comprises n-methylol (meth)acrylamide monomer for improving adhesion of the seed coating resin to the dry powder. Another example of a suitable seed coating resin is “Ridgetex 3311 P” that is manufactured by Ridgemonde Chemicals & Resin SDN.

In other embodiments, a seed may be prepared by other methods known in the art.

### Experimental Results

Table 1 below includes non-limiting examples of systems comprising a plurality of components:

TABLE 1

| | Formula (g) | | | | | | | | | |
|---|---|---|---|---|---|---|---|---|---|---|
| | | | Worm | | | | | Talcum | Mg | |
| | Fertilizer | SAP | Casting | GA3 | ECM | GA4 + 7 | MCC | Powder | Stearate | Colouring |
| Control | 0 | 0 | 0 | 0 | 0 | 0 | 0 | 0 | 0 | 0 |
| Example 1 | 10-40 | 100-400 | 350-700 | 0 | 0 | 0 | 50-200 | 25-80 | 20-80 | 1-10 |
| Example 2 | 10-40 | 100-400 | 350-700 | 0.01-0.10 | 0 | 0.08-0.35 | 50-200 | 25-80 | 20-80 | 1-10 |
| Example 3 | 10-40 | 100-400 | 350-700 | 0.01-0.10 | 40-80 | 0.08-0.35 | 50-200 | 25-80 | 20-80 | 1-10 |
| Example 4 | 10-40 | 100-400 | 350-700 | 0 | 40-80 | 0.08-0.35 | 50-200 | 25-80 | 20-80 | 1-10 |
| Example 5 | 10-40 | 100-400 | 350-700 | 0.01-0.10 | 40-80 | 0.00 | 50-200 | 25-80 | 20-80 | 1-10 |
| Example 6 | 0 | 100-400 | 350-700 | 0.01-0.10 | 0 | 0.08-0.35 | 50-200 | 25-80 | 20-80 | 1-10 |
| Example 7 | 0 | 100-400 | 350-700 | 0.01-0.10 | 40-80 | 0.08-0.35 | 50-200 | 25-80 | 20-80 | 1-10 |

For clarity, in Table 1, “GA3” refers to gibberellin A3, “MCC” refers to microcrystalline cellulose, “SAP” refers to super absorbent polymer, “GA4+7” refers to gibberellin A4 and gibberellin A7, and “Mg Stearate” refers to magnesium stearate. The components were pressed together.

Worm castings is a composition comprising a plurality of components including, but not limited to, dry matter, nitrogen content, phosphorous content, potassium content, organic matter, calcium, and magnesium. In some embodiments, trace elements including, but not limited to, trace elements selected from the group consisting of sodium, aluminum, boron, copper, iron, manganese, zinc, and a combination thereof are also present in the worm castings. The worm castings contemplated herein generally have a dry matter content of between about 30% to about 40%, a total nitrogen content of between about 0.6% to about 1.0%, a total phosphorus content of between about 0.08% and about 0.12%, a total potassium content of between about 0.06% and about 0.08%, and an organic matter content of between about 25% and about 30%. As contemplated in this embodiment, the worm castings have a pH of between about 4.2 and about 4.4 (e.g. 4.21, 4.22, 4.23, 4.24, 4.25, 4.26, 4.27, 4.28, 4.29, 4.30). As contemplated in this embodiment, the carbon to nitrogen ratio in the worm castings is between about 20:1 to about 15:1 (e.g. 15:1, 16:1, 17:1, 18:1, 19:1).

The water controlling agent (e.g. SAP) to organic waste material (e.g. worm casting) ratio can be between about 1:1 and about 1:7. For example, the water controlling agent (e.g. SAP) to organic waste material (e.g. worm casting) ratio can be between about 1:1 and about 1:6, about 1:1 and about 1:5, about 1:1 and about 1:4, about 1:1 and about 1:3, about 1:1 and about 1:2. For example, the water controlling agent (e.g. SAP) to organic waste material (e.g. worm casting) ratio can be about 1:1, about 1:2, about 1:3, about 1:4, about 1.5, about 1:6, about 1:7.

The GA3 to GA 4+7 ratio can be between about 1:35 and about 1:1. For example, the GA3 to GA 4+7 ratio can be between about 1:30 and about 1:1, about 1:25 and about 1:1, about 1:20 and about 1:1, about 1:15 and about 1:1, about 1:10 and about 1:1, about 1:5 and about 1:1. For example, the GA3 to GA 4+7 ratio can be about 1:2, about 1:4, about 1:6, about 1:8, about 1:10.

The organic waste material (e.g. worm casting) to GA3 ratio can be between about 10000:1 and about 20000:1. For example, the organic waste material (e.g. worm casting) to GA3 ratio can be between about 13000:1 and about 19000:1, about 14000:1 and about 18000:1, about 15000:1 and about 18000:1, about 16000:1 and about 18000:1, about 16000:1 and about 17000:1. For example, the organic waste material (e.g. worm casting) to GA3 ratio can be about 15000:1, about 15500:1, about 16000:1, about 16500:1, about 17000:1, about 17500:1.

The water controlling agent (e.g. SAP) to flow control agent (e.g. magnesium stearate) ratio can be between about 20:1 and about 2:1. For example, the water controlling agent (e.g. SAP) to flow control agent (e.g. magnesium stearate) ratio can be between about 20:1 and about 4:1, about 20:1 and about 6:1, about 20:1 and about 8:1, about 20:1 and about 10:1, about 15:1 and about 2:1, about 15:1 and about 4:1, about 15:1 and about 6:1, about 15:1 and about 8:1, about 15:1 and about 10:1. For example, the water controlling agent (e.g. SAP) to flow control agent (e.g. magnesium stearate) ratio can be about 10:1, about 12:1, about 14:1, about 16:1.

The organic waste material (e.g. worm casting) to flow control agent (e.g. magnesium stearate) ratio can be between about 35:1 and about 18:1. For example, the organic waste material (e.g. worm casting) to flow control agent (e.g. magnesium stearate) ratio can be between 30:1 and 20:1, 28:1 and 22:1, 26:1 and 24:1, 26:1 and 22:1. For example, the organic waste material (e.g. worm casting) to flow control agent (e.g. magnesium stearate) ratio can be about 20:1, about 25:1, about 30:1.

A small hole was introduced into each example composition (e.g. Example 1, Example 2, Example 3, Example 4, Example 5, Example 6, Example 7). A seed was placed in the hole. The combination of a seed and example composition is referred herein as a “TGM”. Garden soil (TopSoil Plus, Green Harvest, Westland Ltd, Balzac Alberta) was placed in germination trays. The soil depth in the tray was about an inch. The TGMs were placed on the soil. The TGMs were irrigated until the soil below it was saturated with water (or until field capacity). The trays containing the TGMs were kept at room temperature (about 25° C.). Each germination tray contained 10 TGMs. Germination trays which contained garden soil on which seeds (e.g. Douglas fir, Lodgepole pine, Jackpine and white spruce seeds) were dropped on the soil surface served as control. A seed was considered “germinated” when the radicle of a plant had elongated to 2-3 mm.

The emergence rate was estimated with a modified Rozema index of germination rate, Σ (100Gi/(nti)), where n is the number of seeds used in the experiment and Gi is the number of seedlings that emerged on day tᵢ (tᵢ=0, 1, 2, 3, . . . ) (Zheng Y, et al., 2005. Effects of burial in sand and water supply regime on seedling emergence of six species. Ann Bot 95:1237-1245). Final percentage emergence was arcsine square root transformed before analysis to ensure homogeneity of variance. Untransformed values of emergence rate were used as these were found to be homogeneous. A two-way ANOVA at the 95% probability level was conducted to compare treatment effects. Tukey's HSD test was used to determine mean differences between treatments when significant differences were found.

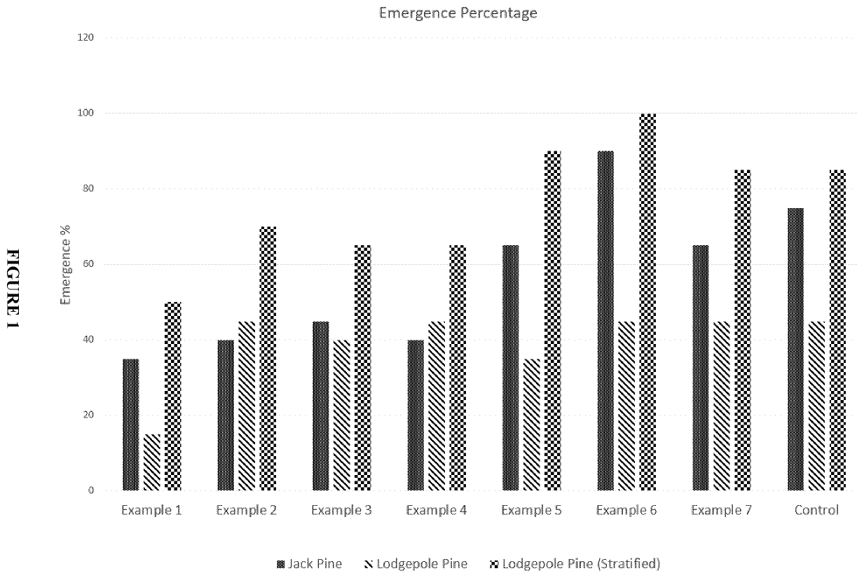

The germination performance of the various TGMs can be summarized in FIG. 1. Example 6 described in Table 1 exhibited germination rates for Lodgepole pine and Jack pine that exceeded the control and the other examples.

In addition to Table 1, Table 2 below includes non-limiting examples of other systems comprising a plurality of components:

TABLE 2

| | Formula (g) | | | | | | | | | |
|---|---|---|---|---|---|---|---|---|---|---|
| | | | Worm | | | | | Talcum | Mg | |
| | Fertilizer | SAP | Casting | GA3 | ECM | GA4 + 7 | MCC | Powder | Stearate | Colouring |
| Control | 0 | 0 | 0 | 0 | 0 | 0 | 0 | 0 | 0 | 0 |
| Example 5.0 | 10-40 | 100-400 | 350-700 | 0.01-0.05 | 40-80 | 0.00 | 50-200 | 25-80 | 20-80 | 1-10 |
| Example 5.1 | 10-40 | 100- 400 | 350-700 | 0.01-0.10 | 40-80 | 0.08-0.35 | 50-200 | 25-80 | 20-80 | 1-10 |
| Example 5.2 | 10-40 | 200-300 | 450-550 | 0.07-0.10 | 40-80 | 0.00 | 70-120 | 40-65 | 20-30 | 1-10 |
| Example 6.0 | 0 | 100-400 | 350-700 | 0.01-0.05 | 0 | 0.10-0.18 | 50-200 | 25-80 | 20-80 | 1-10 |
| Example 6.1 | 0 | 100-400 | 350-700 | 0.02-0.10 | 0 | 0.02-0.35 | 50-200 | 25-80 | 20-80 | 1-10 |
| Example 6.2 | 0 | 200-300 | 450-550 | 0.01-0.04 | 0 | 0 | 70-120 | 40-65 | 20-30 | 1-10 |
| Example 7.0 | 0 | 100-400 | 350-700 | 0.01-0.04 | 40-80 | 0.08-0.35 | 50-200 | 25-80 | 20-80 | 1-10 |
| Example 7.1 | 0 | 100-400 | 350-700 | 0.01-0.10 | 40-80 | 0 | 50-200 | 25-80 | 20-80 | 1-10 |
| Example 7.2 | 0 | 200-300 | 450-550 | 0.06-0.08 | 40-80 | 0.08-0.35 | 70-120 | 40-65 | 20-30 | 1-10 |

To create the example compositions described in Tables 1 and 2, the components of each example composition were combined together. A small hole was introduced into each example composition (e.g. Example 5.0, Example 5.1, Example 5.2, Example 6.0, Example 6.1, Example 6.2, Example 7.0, Example 7.1, Example 7.2). A seed was placed in the hole. The combination of a seed and example composition is referred herein as a “TGM”. Garden soil (TopSoil Plus, Green Harvest, Westland Ltd, Balzac Alberta) was placed in germination trays. The soil depth in the tray was about an inch. The TGMs were placed on the soil. The TGMs were irrigated until the soil below the TGMs is saturated with water. The trays containing the TGMs were kept at room temperature (about 25° C.). Each germination tray contained 10 TGMs. Germination trays which contained garden soil on which seeds (e.g. Douglas fir, Lodgepole pine, Jackpine and white spruce seeds) were dropped on the soil surface served as control. A seed was considered “germinated” when the radicle of a plant had elongated to 2-3 mm. The emergence rate was estimated with a modified Rozema index of germination rate, Σ(100Gᵢ/(ntᵢ)), where n is the number of seeds used in the experiment and Gᵢ is the number of seedlings that emerged on day tᵢ (tᵢ=0, 1, 2, 3, . . . ) (Zheng Y, et al. (2005) Effects of burial in sand and water supply regime on seedling emergence of six species. Ann Bot 95:1237-1245). Final percentage emergence was arcsine square root transformed before analysis to ensure homogeneity of variance. Untransformed values of emergence rate were used as these were found to be homogeneous. A two-way ANOVA at the 95% probability level was conducted to compare treatment effects. Tukey's HSD test was used to determine mean differences between treatments when significant differences were found.

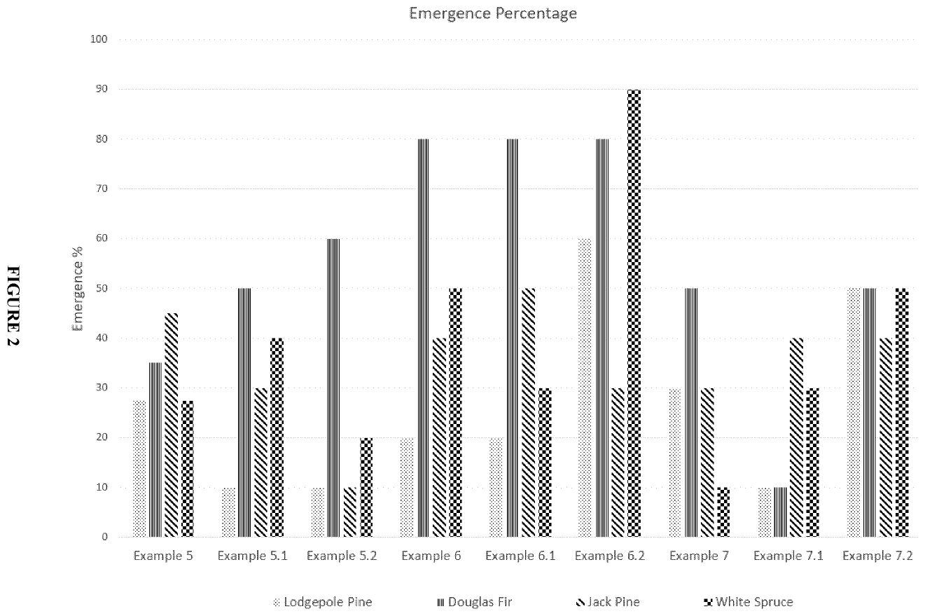

The germination performance of the various TGMs can be summarized in FIG. 2. Example 6.2 described in Table 2 performed the best in terms of seed germination percentage, relative to the other examples in Table 2.

### Example of System 100

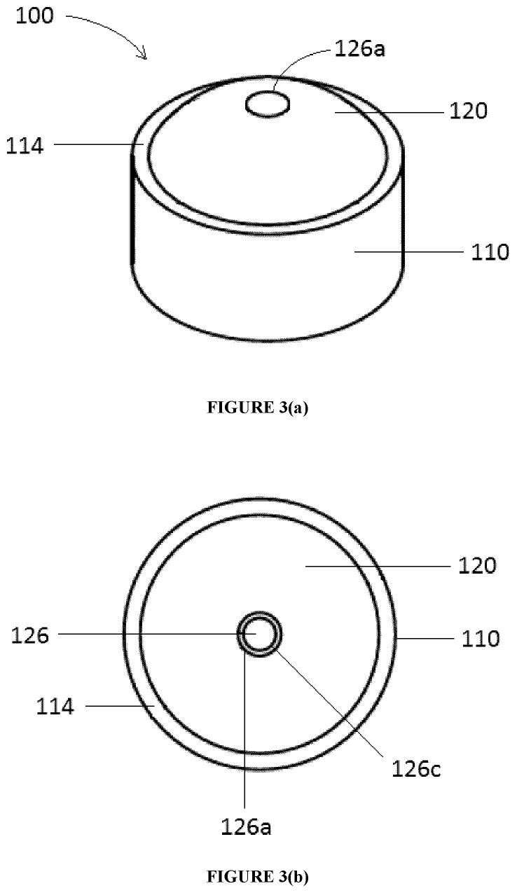

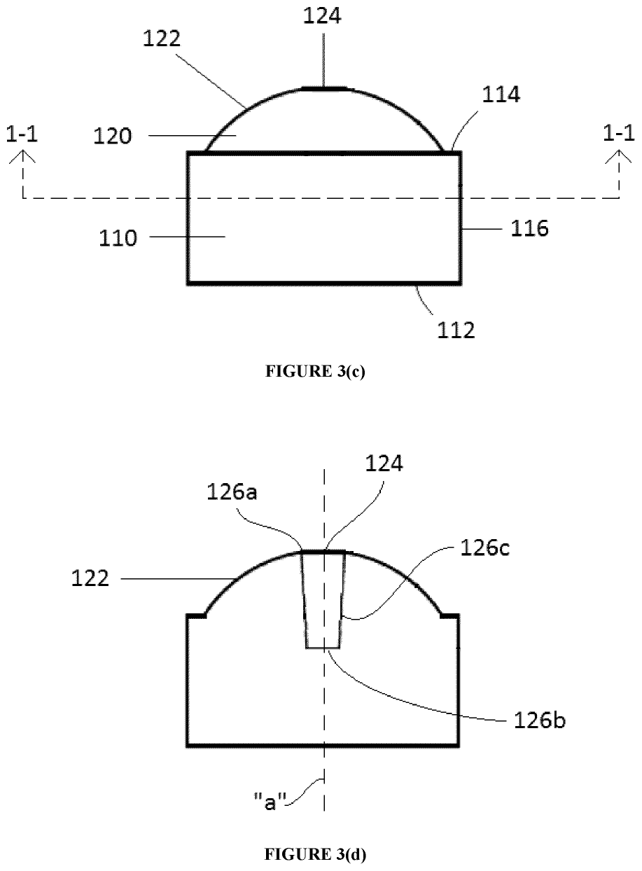

In an embodiment, and as depicted in FIGS. 3(a) to 3(d), there is a system 100 for providing nutrients to plantlets in the form of a tablet. The system 100 comprises two portions: a base 110 and a top 120. As depicted in this embodiment, the base 110 is in the shape of a cylinder and comprises a bottom surface 112, a top surface 114, and a side-wall surface 116 extending therebetween. In other embodiments, the base may be another suitable shape.

As depicted in this embodiment, the top 120 is a semi-sphere and forms a surface 122 that is convexed and extends away from the top surface 114. In other embodiments, the top may be of another shape. Base 110 and top 120 are continuous with one another. That is, while base 110 and top 120 define different spatial volumes within the system 100, they are not separate portions thereof. In other embodiments, the base and the top of the system can be separate components and coupled together by means known in the art.

The system 100 further comprises a receptacle 126 (e.g. a hole), the receptacle 126 comprising a first end 126a (e.g. an opening), a second end 126b, and a sidewall 126c extending therebetween. The first end 126a of the receptacle 126 is disposed at surface 122. In this embodiment, and as shown in FIG. 3(d), the receptacle 126 extends along an axis “a”, said axis extending through apex 124 of the top 120 and perpendicular to bottom 110. In other embodiments, the receptacle can extend along another axis that intersects with the top 120.

As depicted in this embodiment, the receptacle 126 has a frustoconical shape. In other embodiments, the receptacle can have another suitable shape as such, but not limited to frusto-pyramidal, conical, and pyramidal.

As depicted in this embodiment, a portion of receptacle 126 extends into the spatial volume defined by bottom 110. In other embodiments, the receptacle does not extend into the spatial volume defined by bottom 110 and remains entirely contained within the spatial volume of top 120.

### Example of System 200

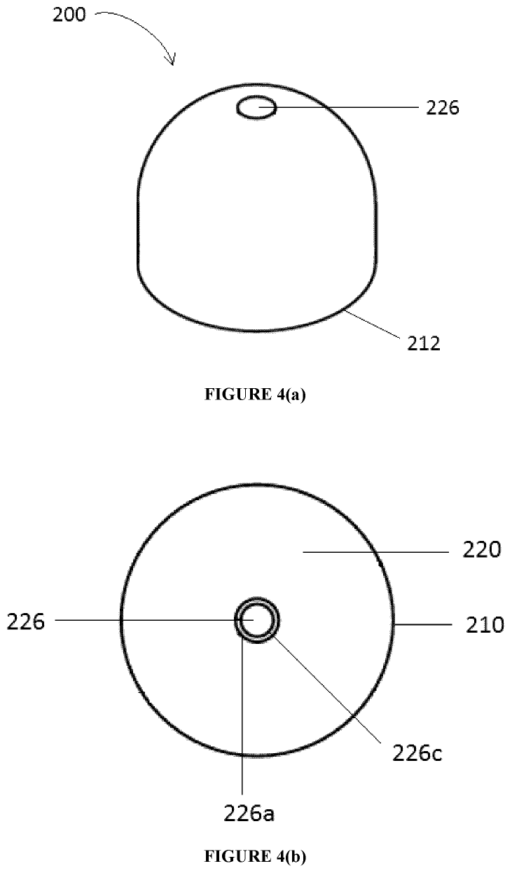

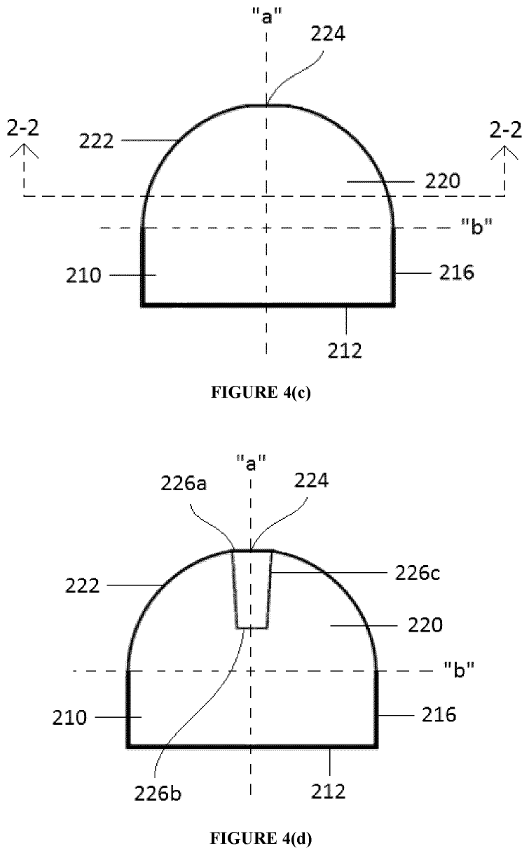

In an embodiment, and as depicted in FIGS. 4(a) to 4(d), there is a system 200 for providing nutrients to plantlets in the form of a tablet. The system 200 comprises two portions: a base 210 and a top 220. The base 210 is in the shape of a cylinder and comprises a bottom surface 212 and a side-wall surface 216 extending upwards therefrom until axis “b”. In other embodiments, the base may be another suitable shape.

As depicted in this embodiment, the top 220 is a semi-sphere and forms a surface 222 that is convex and that is continuous with side-wall surface 216. In other embodiments, the top may be of another shape. Base 210 and top 220 are continuous with one another. That is, while base 210 and top 220 define different spatial volumes within the system 200, they are not separate components thereof. In other embodiments, the base and the top of the water imbibing unit may be separate components and coupled together by means known in the art.

The system 200 further comprises a receptacle 226 (e.g. a hole), the receptacle 226 comprising a first end 226a (e.g. an opening), a second end 226b, and a sidewall 226c extending therebetween. The first end 226a of the receptacle 226 is disposed at surface 222. As shown in this embodiment, the receptacle 226 extends along an axis “a”, said axis extending through apex 224 of the top 220 and perpendicular to bottom 210. In other embodiments, the receptacle can extend along another axis that intersects with the top 220.

As depicted in this embodiment, the receptacle 226 has a frustoconical shape. In other embodiments, the receptacle can have another suitable shape as such, but not limited to frusto-pyramidal, conical, and pyramidal.

As depicted in this embodiment, receptacle 226 does not extend into the spatial volume defined by bottom 210 and remains entirely contained within the spatial volume of top 220. In other embodiments, the receptacle may extend into the spatial volume defined by bottom 210.

From at least a manufacturing perspective, a flat bottom provides a benefit in that the system may be conveniently oriented “right-side” up as it go through the seeder (i.e. an apparatus for inserting a seed into a receptacle of a system). From a manufacturing perspective, a convex surface (e.g. surface 122 or surface 222) provides the benefit of at least: (i) permitting a system to “re-orient” itself “right-side” up in the event that the system is not; and (ii) minimizes the likelihood that a receptacle would be filled with more than one seed.

### General

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

What is claimed is:

1. A system for providing nutrients to plantlets, the system comprising a water controlling agent, an organic waste material, a seed germination enhancer, and a binding material, wherein the ratio of the water controlling agent to the organic waste material is between about 1:1 and about 1:6.

2. The system as claimed in claim 1, wherein the water controlling agent is selected from the group consisting of an acrylate polymer, a super absorbent polymer, and a combination thereof.

3. The system as claimed in claim 2, wherein the water controlling agent is the super absorbent polymer.

4. The system as claimed in claim 1, wherein the organic waste material is worm casting.

5. The system as claimed in claim 4, wherein the worm casting is derived from Red Wrigglers.

6. The system as claimed in claim 1, wherein the seed germination enhancer is selected from the group consisting of a gibberellin, an auxin, and a combination thereof.

7. The system as claimed in claim 1, wherein the seed germination enhancer is a gibberellin.

8. The system as claimed in claim 6, wherein the gibberellin is selected from the group consisting of GA3, GA 4+7, and a combination thereof.

9. The system as claimed in claim 8, wherein the gibberellin is GA3.

10. The system as claimed in claim 8, wherein the gibberellin is a combination of GA3 and GA 4+7.

11. The system as claimed in claim 1, wherein the binding material is microcrystalline cellulose.

12. The system as claimed in claim 1, wherein the ratio of the water controlling agent to the organic waste material is between about 1:1 and about 1:3.

13. The system as claimed in claim 12, wherein the ratio of the water controlling agent to the organic waste material is between about 1:2.

14. The system as claimed in claim 1, wherein the ratio of the organic waste material to the seed germination enhancer is between about 13000:1 and about 19000:1.

15. The system as claimed in claim 14, wherein the ratio of the organic waste material to the seed germination enhancer is between about 16000:1 and about 18000:1.

16. The system as claimed in claim 1, wherein the ratio of water controlling agent to flow agent is between about 20:1 and about 2:1.

17. The system as claimed in claim 16, wherein the ratio of water controlling agent to flow agent is between about 15:1 and about 10:1.

18. The system as claimed in claim 1, wherein the system does not comprise a fungal material.
